(19) United States
(12) Patent Application Publication
(10) Pub. No.: US 2003/0160768 A1
(43) Pub. Date: Aug. 28, 2003

(54) Touch panel

(76) Inventors: Koji Tanabe, Osaka (JP); Toshiharu Fukui, Nara (JP); Kenichi Takabatake, Osaka (JP); Kenichi Matsumoto, Osaka (JP)

Correspondence Address: RATNERPRESTIA, P O BOX 980, VALLEY FORGE, PA, 19482-0980, US

(21) Appl. No.: 10/341,938

(22) Filed: Jan. 14, 2003

(30) Foreign Application Priority Data
Jan. 21, 2002 (JP) 2002-11356
Apr. 5, 2002 (JP) 2002-103298

(51) Int. Cl. G09G 5/00

(52) U.S. Cl. 345/173

(57) ABSTRACT

A touch panel includes an upper substrate having an upper electrode thereon, a lower substrate having a lower electrode thereon, and a spacer for bonding the substrates to each other. The spacer contains bubbles and has an elastic property. The touch panel has small dimensions while having a desired effective size of its operable area.

### FIELD OF THE INVENTION

The present invention relates to a touch panel used for operating electronic apparatuses.

### BACKGROUND OF INVENTION

Having been improved in their function and versatility, electronic apparatuses are commonly equipped with touch panels provided on front sides of display units of the apparatuses, such as LCDs, for displaying characters, symbols, and icons, which are then identified and selectively operated to perform their corresponding functions.

FIG. 3 is a cross sectional view of a conventional touch panel. The panel includes an upper light-transmittable electrode 2 provided under an upper light-transmittable substrate 1 and a pair of upper electrode wiring (not shown) connected to respective ends of the upper electrode 2. The touch panel includes a lower light-transmittable electrode 4, which is identical to the upper electrode 2, provided over a lower light-transmittable substrate 3 and a pair of lower electrode wiring (not shown) connected to respective ends of the lower electrode 4 as arranged perpendicularly to the upper electrode wiring. The lower substrate 3 is provided with plural dot spacers 5 thereon at equal intervals, thus being distanced from the upper electrode 2. A spacer 6 shaped like a frame made of, for example, unwoven fabric or polyester film, is provided at each of its upper and lower sides with an adhesive 6A. The upper substrate 1 and the lower substrate 3 are then bonded to each other along their frame with the adhesive 6A so that the upper electrode 2 and the lower electrode 4 separate from each other by a distance. Thus, the touch panel is provided.

The upper electrode wiring and the lower electrode wiring of the touch panel are connected to a detecting circuit in the electronic apparatuses. Then, the upper surface excluding an area corresponding to the spacer 6, i.e., an operable area of the upper substrate 1 capable of being identified, is pressed down by a finger or pen. This causes a pressed portion of the upper substrate 1 to deflect and permit direct contact between the upper electrode 2 and the lower electrode 4. The contacting position can thus be detected from the ratio between resistances of the upper electrode wiring and the lower electrode wiring.

The dot spacer 5 is provided for preventing the electrodes 2 and 4 from unnecessarily contacting each other upon the pressing. The spacer 5 is shaped like a cannonball having a height of about 10 μm and is provided with a predetermined space against the electrode 2.

In the conventional touch panel, however, the upper electrode 2 is stressed and deteriorated particularly at a portion adjacent to the spacer 6 when the electrode 2 is pressed with the finger or pen repetitively. As the result, the portion adjacent to the spacer 6 of the operable area may be regarded as a non-operable area. Accordingly, the operable area needs an additional area to compensate the non-operable area, thus increasing the overall size of the touch panel.

### SUMMARY OF THE INVENTION

A touch panel includes a first substrate having a first electrode provided on a surface thereof, a second substrate having a second electrode provided on a surface thereof and spaced by a distance from the first substrate, and a spacer provided between the first and substrates. The spacer is elastic and includes a bubble therein.

The touch panel has reduced dimensions while having an enough effective size of an operable area.

### BRIEF DESCRIPTION OF THE DRAWINGS

FIG. 1 is a cross sectional view of a touch panel according to exemplary embodiment 1 of the present invention.

FIG. 2 is a cross sectional view of a touch panel according to exemplary embodiment 2 of the invention.

FIG. 3 is a cross sectional view of a conventional touch panel.

### DESCRIPTION OF THE PREFERRED EMBODIMENTS

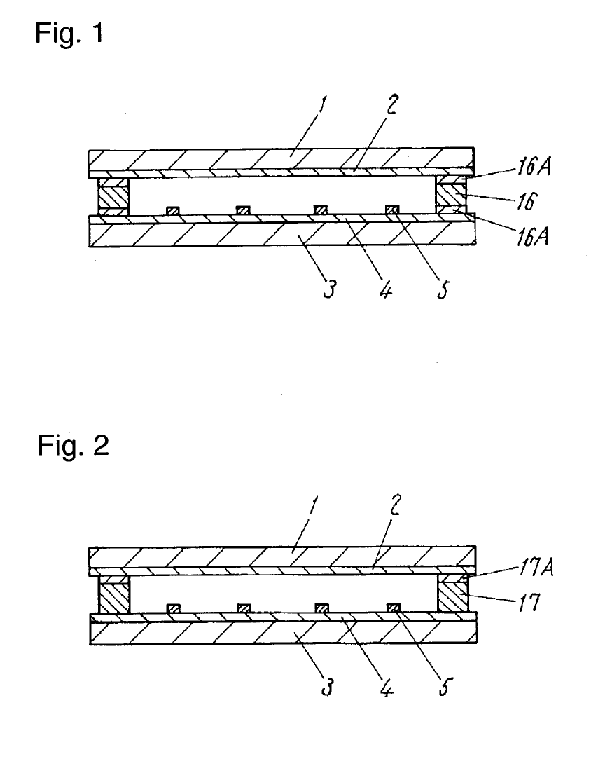

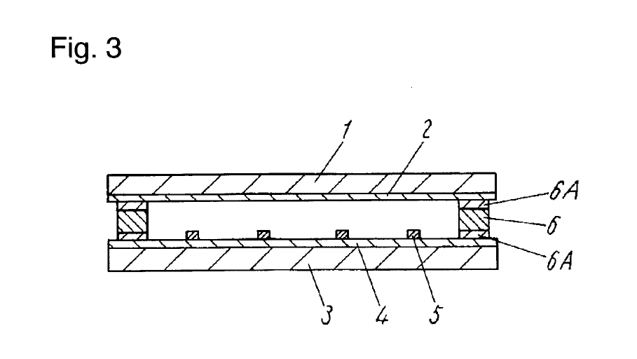

Exemplary embodiments of the present invention will be described referring to FIGS. 1 and 2. Like components are denoted by like numeral as those of the conventional touch panel and will be explained in no more detail.

(Embodiment 1)

FIG. 1 is a cross sectional view of a touch panel according to Embodiment 1 of the present invention. An upper light-transmittable electrode 2 is deposited by vacuum sputtering of indium oxide or tin oxide on the lower surface of an upper light-transmittable substrate 1 made of e.g. polyethylene terephthalate or polycarbonate film. A pair of upper electrode wiring (not shown) are provided on both ends of the upper electrode 2 by patterning paste of silver or carbon. Similarly, a lower light-transmittable electrode 4 identical to the upper electrode 2 is deposited on the upper surface of a lower light-transmittable substrate 3 made of e.g. glass, acryl resin, or polycarbonate resin. A pair of lower electrode wiring (not shown), which are identical to those of the upper electrode 2, are provided on both ends of the lower electrode 4 as arranged perpendicularly to the upper electrode wiring pair. The lower substrate 3 is provided thereon with plural dot spacers 5 made of light-transmittable insulating material, such as epoxy or silicone, at equal intervals, thus being distanced from the upper electrode 2. A spacer 16 shaped like a frame is formed at a frame around a operable area of the panel. The spacer 16 is prepared by heating and foaming rubber resin material, such as urethane, chloroprene, silicon, or fluorine rubber resin, doped with a foaming agent, such as azobisisobutylnitryl, and thus being elastic. The spacer 16 is then coated at each of upper and lower sides with a thermoplastic resin adhesive 16A, such as acrylic resin or polyester resin. The upper substrate 1 and the lower substrate 3 are bonded to each other along their frames with the adhesive 16A so that the upper electrode 2 and the lower electrode 4 separate from each other by a distance. Thus, the touch panel is provided.

Alternatively, the spacer 16 may be prepared by printing elastic synthetic resin including thermally expandable micro-capsules dispersed therein along the frame on the lower electrode 4 and heating it for developing foams. The spacer 16 is then coated at the upper side with a thermoplastic resin adhesive 16A, such as acrylic or polyester resin. The touch panel is completed upon the upper substrate 1 and the lower substrate 3 being bonded to each other with the adhesive 16A.

The thermally expandable micro-capsules are commercially available as EXPANCEL of Nippon Phyllite Co., Ltd. or MATSUMOTO MICROSPHERE of Matsumoto Yushi-Seiyaku Co., Ltd.

The elastic synthetic resin may preferably be of a cure-crosslinking type, such as urethane resin, urethane denatured epoxy resin, phenoxy resin, urethane bridged polyester resin, silicone rubber, fluorine rubber, chloroprene-phenol rubber, and butylal denatured phenol resin.

The dot spacer 5 can include foams. However, the spacer 5 ordinarily has a height of about 10 μm, and it may thus be difficult to have the spacer include foams.

The upper electrode wiring and the lower electrode wiring of the touch panel are connected to a detecting circuit in the electronic apparatuses. Then, the upper surface excluding an area corresponding to the spacer 6, i.e., an operable area of the upper substrate 1 capable of being identified, is pressed down by a finger or pen. This causes a pressed portion of the upper substrate 1 to deflect and permit direct contact between the upper electrode 2 and the lower electrode 4. The contacting position can thus be detected from the ratio between resistances of the upper electrode wiring and the lower electrode wiring.

The dot spacer 5 is provided for preventing the electrodes 2 and 4 from unnecessarily contacting each other upon the pressing.

A method of manufacturing and evaluating the spacer 16 will be described in more detail.

First, thermoset resin material including 80% by weight of polyester resin (#300 of Toyobo.co.,Ltd) and 20% by weight of curing isocyanate agent (G8009B of Kyoto Elec) is provided with 5% by weight of thermally-expandable micro-capsules (Matsumoto Microsphere 82-D of Matsumoto Yushi-Seiyaku Co., Ltd) to prepare paste. The paste is printed in a desired pattern on a film of polyester by 100-mesh screen coating technique and dried at 150 to 160° C. for 5 minutes to build the spacer 16.

With the dosage of the thermally expandable micro-capsules being varied, six types of touch panels No.1 to No.6 were fabricated. The panels are different from each other in the ratio of a change in a thickness of the spacer 16 upon being urged by a pressure of 100 g/mm² to a thickness before the pressing.

The touch panel was then pressed down at a point distanced by 1.5 mm inward from the spacer 16 by a force of 500 g with a polyacetal pen having a 0.8 mm diameter at its tip end. The pen was slid by 30 mm in parallel to the spacer 16. This was repeated 150,000 times, and the resistance at a pressed point was measured.

The result of evaluation is shown in Table 1. The symbol “G” represents a good result in which the ratio of an actual measurement of the resistance and a theoretical resistance is within a given range while the symbol “x” represents a no-good result in which the ratio is out of the range.

TABLE 1

| | Ratio of | | | |
|---|---|---|---|---|
| Spacer | Thickness | Result of Evaluation | | |
| No. | Change (%) | 50,000 times | 100,000 times | 150,000 times |
| 1 | 0 | x | x | x |
| 2 | 12 | x | x | x |
| 3 | 26 | G | x | x |
| 4 | 48 | G | G | G |
| 5 | 69 | G | G | G |
| 6 | 83 | G | G | G |

As apparent from Table 1, the spacers No.3 to No.6 having thicknesses changing by greater than 20% are more favorable in the resistance than the spacer No.1 which is not elastic and the spacer No.2 changing 10% in its thickness.

Having the ratio of thickness change exceeding 80%, the spacer 16 became too elastic to hold the upper substrate 1 during the pressing. Since the upper substrate 1 was displaced leftward or rightward upon being pressed down, the point of the pressing hardly remained at its original position.

As discussed, the touch panel having the favorable resistance and the pressed point which is hardly displaced is provided upon having the ratio of the change of thickness, when being urged by a pressure of 100 g/mm², ranging preferably from 20% to 80% or more preferably from 40% to 70%.

The touch panel according to embodiment 1 includes the lower substrate 3 spaced from the upper substrate 1 by the spacer 16 which contains air bubbles and thus is elastic. When the touch panel is pressed down at a portion adjacent to the spacer 16, the spacer 16 is compressed and thus reduces the stress of bending the upper electrode 2. Accordingly, the touch panel has the operable area adjacent to the spacer 16 effectively used.

Also, at least either the upper substrate 1 or the lower substrate 3 is coated with the synthetic resin containing thermally expandable micro-capsules dispersed and is turned by heating to the spacer 16. This arrangement makes the touch panel inexpensive since the adhesive 16A is applied only to one substrate for bonding the spacer 16 between the two substrates.

Since the spacer 16, having a thickness when being urged by a pressure of 100 g/mm² stays from 20% to 80% of its original thickness, the stress of bending adjacent to the spacer 16 can be reduced on the upper substrate 2, thus preventing the substrate 2 from quick deterioration and from having the pressed point displaced.

(Embodiment 2)

A touch panel according to exemplary embodiment 2 of the present invention will be described. Like components are denoted by like numerals as those of embodiment 1 and will be explained in no more detail.

FIG. 2 is a cross sectional view of the touch panel of embodiment 2. A spacer 17 is manufactured by coating the upper surface of the lower electrode 4 with a desired pattern of elastic synthetic resin paste, such as urethane resin, silicon rubber, or fluorine rubber, which has air bubbles dispersed therein and is then cured. The spacer 17 is then coated at its upper surface with a thermoplastic resin adhesive 17A, such as acrylic resin or polyester resin. The upper substrate 1 and the lower substrate 3 are bonded to each other by the adhesive 17A, thus providing the touch panel.

The dispersion of air bubbles in the synthetic resin paste may be implemented by charging air bubbles directly into the elastic synthetic resin or rubber paste with the use of an applicable apparatus, for example, a PENGAMFOAM SYSTEM of SUNSTAR ENGINEERING Inc. The paste is applied in a desired pattern by screen printing or a dispenser and dried to develop the spacer 17.

When the dispenser is used, the paste having air bubbles dispersed therein can directly be applied. Since the paste is stirred before printed in the screen printing, it may preferably be doped with a stabilizer, such as a surface active agent, namely zinc stearate, for preventing the air bubbles from being eliminated.

The spacer 17 is made from the paste of urethane resin, silicon rubber, or fluorine rubber which includes air bubbles dispersed therein allows the touch panel of embodiment 2 to be improved in spring-back effect after the pressing and to thus have operational reliability.

Since the paste contains a surface active agent for physically stabilizing the air bubbles, the spacer 17 can be inhibited from having the air bubbles eliminated during the screen printing, hence contributing to the lower price of the touch panel.

What is claimed is:

1. A touch panel comprising:
a first substrate having a first electrode provided on a surface thereof;
a second substrate having a second electrode provided on a surface thereof and spaced by a distance from said first substrate; and
a spacer provided between said first and second substrates, said spacer being elastic and including a bubble therein.

2. The touch panel according to claim 1, wherein the spacer is fabricated by applying, to said first substrate, a resin having thermally expandable micro-capsules dispersed therein and by drying said resin material.

3. The touch panel according to claim 1, wherein said spacer is fabricated by applying, to said first substrate, a resin having a bubble dispersed therein, said resin being made of one of urethane resin, silicon rubber, and fluorine rubber, and by drying the resin material.

4. The touch panel according to claim 3, wherein said resin contains surface active agent for physically stabilizing said bubble.

5. The touch panel according to claim 1, wherein said spacer has a thickness ranging from 20% to 80% of an original thickness of said spacer when being urged by a pressure of 100 g/mm².

6. A method of fabricating a touch panel, comprising the steps of:
preparing a first substrate having a first electrode provided on a first surface thereof, and a second substrate having a second electrode provided on a first surface thereof;
providing a spacer on the first surface of the fist substrate, the spacer being elastic and including a bubble therein; and
bonding the first surface of the second substrate to the spacer.

7. The method according to claim 6, further comprising the step of:
providing an adhesive on the spacer,
wherein said step of bonding the first surface of the second substrate to the spacer includes the sub-step of bonding the spacer to the first surface of the second substrate by the adhesive.

8. The method according to claim 6, wherein said step of providing the resin includes the sub-steps of:
applying resin having thermally expandable micro-capsules dispersed therein on the first surface of the first substrate; and
heating the applied resin.

9. The method according to claim 6, wherein said step of providing the resin includes the sub-steps of:
applying, on the first surface of the first substrate, paste of one of urethane resin, silicon rubber, and fluorine rubber, the paste having a bubble dispersed therein; and
curing the applied paste.

10. The method according to claim 9, wherein the paste contains surface active agent for physically stabilizing the bubble.
